(19) United States
(12) Patent Application Publication
(10) Pub. No.: US 2025/0303372 A1
(43) Pub. Date: Oct. 2, 2025

(54) LIGHTWEIGHT NANOBUBBLE GENERATOR

(71) Applicant: Nano and Advanced Materials Institute Limited, Hong Kong (HK)

(72) Inventors: Yee Hau CHENG, Hong Kong (HK); Koon Yee LIN, Hong Kong (HK); Sum Hang Grace POON, Hong Kong (HK)

(21) Appl. No.: 18/623,069

(22) Filed: Apr. 1, 2024

(51) Int. Cl. B01F 25/312; B01F 23/232; B01F 35/00; B01F 101/00; C02F 1/72; C02F 1/74; C02F 1/78

(52) U.S. Cl. CPC B01F 25/3121; B01F 23/232; B01F 25/31242; B01F 35/187; C02F 1/727; C02F 1/74; C02F 1/78; B01F 2101/305

(57) ABSTRACT

The present invention relates to provides a lightweight, free-standing, non-electricity driven nanobubble generating device, which can be applied to water faucets with municipal water supplies. In comparison to the common electricity-driven nanobubble generators, the nanobubble generating device of the present invention utilizes the Venturi effect for gas introduction and bubble formation, and no water pumps are needed for operation, therefore compactness is achieved. The device of the present invention is also directly applicable to water faucets of municipal water supply, enabling facile nanobubble generation for a wide variety of applications.

### FIELD OF THE INVENTION

The present invention relates to nanobubble generation. In particular, the present invention relates to a novel light-weight and free-standing nanobubble generating device which does not require electrical power or water tank connections, and a method of use thereof.

### BACKGROUND

Nanobubbles are, in general, gas bubbles with diameters on the nanoscale. Due to their unique properties, including significantly higher surface area-to-volume ratio, enhanced solubility and stability, and interfacial phenomena at the gas-liquid interface, nanobubbles are emerging as a new technology, having a multitude of potential applications across different industries.

For example, nanobubbles may be used for wastewater treatment and agriculture for pumping oxygen into wastewater, thereby promoting the oxidation of contaminants and improving water quality.

Agriculture, hydroponic planting, and fisheries may also be major applications for nanobubbles, as the nanobubbles can be a stable vessel for continuous delivery of oxygen and/or nutrients, and potential contamination remediation to the water or soil.

Nanobubbles may also have potential in biomedical and pharmaceutical fields, especially in drug delivery systems for targeted therapies. Given their relative longevity to larger size bubbles or vessels, nanobubbles may have the potential to be developed into stable and reliable vessels for transporting drugs to specific target sites in the body.

Nanobubble technologies may also have large-scale applications in food and beverage industry for various purposes, including emulsification agents, food product preservation, and beverage extraction.

Various other fields are also exploring nanobubble applications, including mineral processing and surface decontamination, utilizing the nanoscale-sized bubbles for tasks which require higher precision and efficiency.

However, the prior art nanobubble generators usually require a water tank or recirculation system to generate nanobubbles, which require electrical power to drive their operation, resulting in large nanobubble generator sizes, limiting mobile application. Thus, there is a need in the art for improved nanobubble generators that do not require electrical power and are small and portable. The present invention addresses this need.

### SUMMARY OF THE INVENTION

Addressing the above technical insufficiencies, the present invention provides a lightweight, free-standing, non-electricity-driven nanobubble generating device, which can be applied to water faucets with municipal water supplies.

In one aspect, the present invention provides a lightweight, free-standing, non-electricity driven and municipal water source-compatible nanobubble generator having a liquid inlet, a liquid outlet, a frustoconical-shaped inlet passage connected to the liquid inlet wherein its wider part is connected to the liquid inlet, multiple stacks (at least 2) of porous layers connected to the liquid outlet, an inverted frustoconical-shaped outlet passage wherein its wider part is connected to the multiple stacks of porous layers, a tubular flow-constricting tunnel interconnecting the narrower part of the frustoconical-shaped inlet passage and the narrower part of the inverted frustoconical-shaped outlet passage, and a gas inlet externally connected to a gas supply, perpendicularly connected to the tubular flow-constricting tunnel.

In an embodiment, the liquid inlet further comprises a filtering mesh of 300 to 350 mesh.

The gas inlet of the nanobubble generating device comprises a non-return valve.

The nanobubble generating device is designed such that, when connected to a liquid flow with a liquid pressure of at least 2 bar and a flow rate of at least 24 LPM, the device generates nanobubbles with a concentration of at least 1×10⁷ particles/ml.

In another embodiment, in the lightweight, free-standing, non-electricity driven and municipal water supply-applicable nanobubble generating device, the ratio of the cross-sectional diameter of the wider part of the frustoconical-shaped inlet passage to the cross-sectional diameter of the tubular flow-constricting tunnel is 1:1.5 to 1:2.

In other embodiment, the ratio of the length of the liquid inlet to the length of the liquid outlet of the lightweight, free-standing, non-electricity driven and municipal water supply-applicable nanobubble generating device is 1:4 to 1:5.

In yet another embodiment, the ratio of the cross-sectional diameter of the wider part of the inverted frustoconical-shaped outlet passage to the cross-sectional diameter of the tubular flow-constricting tunnel of the lightweight, free-standing, non-electricity driven and municipal water supply-applicable nanobubble generating device is 1:4 to 1:5.5.

In yet other embodiment, the multiple stacks of porous layers of the lightweight, free-standing, non-electricity driven and municipal water supply-applicable nanobubble generating device each further comprises at least 2 overlapping rimless coarse membranes with pore size of 70-90 μm.

In another embodiment, the gap between each stack of the multiple stacks of porous layers of the lightweight, free-standing, non-electricity driven and municipal water supply-applicable nanobubble generating device is 2.25-2.75 mm.

In a second aspect of the present invention, a method of generating nanobubbles directly from a water source with the of the lightweight, free-standing, non-electricity driven and municipal water supply-applicable nanobubble generating device is also provided herewith. The method comprises aligning the device to a water supply, connecting an external gas supply to the gas inlet of the device to allow gas supply into the device through the gas inlet, switch on the water supply and control the water flow into the device through the inlet to have a liquid pressure of at least 2 bar and flow rate of at least 24 litres per minute, and receiving the nanobubble flow through the outlet of the device.

In one embodiment of the second aspect of the present invention, the concentration of nanobubbles in the nanobubble flow generated by the lightweight, free-standing, non-electricity driven and municipal water supply-applicable nanobubble generating device is at least 1×10⁷ particles/ml

In another embodiment, the external gas supply of the lightweight, free-standing, non-electricity driven and municipal water supply-applicable nanobubble generating device is selected from ambient air, oxygen concentrator, ozone generator or gas cylinder.

In other embodiment, the nanobubble flow is generated by the lightweight, free-standing, non-electricity driven and municipal water supply-applicable nanobubble generating device without the use of electrical power supply.

### BRIEF DESCRIPTION OF THE DRAWING

FIG. 1 illustrates the design of an embodiment of the lightweight, free-standing, non-electricity driven and municipal water supply-compatible nanobubble generating device.

### DETAILED DESCRIPTION

The present invention relates to a novel light-weight and free-standing nanobubble generating device which does not require electrical power or water tank connection, and a method of use thereof.

The light-weight and free-standing nanobubble generating device does not require external connection to a water tank or rely on any other recirculation systems, thereby optimizing in the compactness of the design of the device.

The novel nanobubble generating device of the present invention can also operate without connecting to any electrical power supply. The device is designed around the concept of bubble generation by drawing gas into the device through the Venturi effect, and further dividing the gas bubbles into nanoscale dimensions by multiple stacks of porous layers.

The Venturi effect describes the phenomenon in which fluid velocity increases as the pipe cross-section decreases; a concomitant decrease in fluid pressure is also a consequence.

The Venturi effect is based on the mathematical expression of the Bernoulli equation, as shown below:

$${p}_{1} - {p}_{2} = \frac{ρ}{2} ( {v}_{2}^{2} - {v}_{1}^{2} )$$

where p₁ and p₂ are the pressure of the fluids in the wider and narrower parts of the pipe, respectively, v₁ and v₂ are the fluid velocities fluids in the wider and narrower parts of the pipe, respectively, and p is the fluid density.

One application of the Venturi effect involves mixing gas into liquid in a partially constricted tube by pumping the gas into the constricted part of the tube, thereby introducing gas into the liquid in the form of gas bubbles. In this invention, the Venturi effect is applied to introduce gas bubbles; the gas bubble dimensions are further reduced by multiple stacks of porous layers to subdivide the bubbles into nanoscale bubbles, as will be discussed in greater depth in the below sections.

The lightweight, free-standing and non-electricity driven nanobubble generating device of the present invention includes a liquid inlet for receiving a liquid flow into the device, and a liquid outlet for outputting a nanobubble flow. The liquid inlet is connected to a wider portion of a frustoconical-shaped passage, which constricts into a tubular flow-constricting tunnel with a significantly reduced cross-section to create the Venturi effect. The flow-constricting tunnel is perpendicularly connected to a gas inlet for gas supply for bubble generation. The liquid flow with generated bubbles then flows through a narrower part of frustoconical-shaped liquid outlet passage connected to multiple stacks of porous layers containing porous membranes with nanoscopic pores. The bubble-infused water passes through the porous membranes causing the bubbles to be subdivided into nanoscale bubbles that are discharged through the nanogenerator outlet.

The following demonstrates an embodiment of the device with particular specifications for optimum nanobubble generation efficiency.

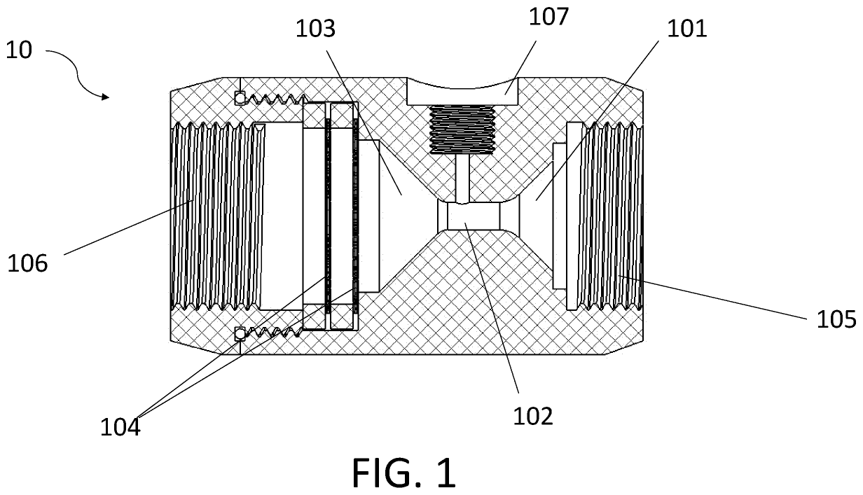

Referring to FIG. 1, the nanobubble generator device 10 comprises a dumbbell-shaped passage. In this example and with reference to FIG. 1, liquid flows through the liquid inlet and the nanobubble flow is discharged through the liquid outlet with a general flow direction from the right to the left.

In FIG. 1, the liquid inlet 105 of the nanobubble generator device 10 includes a filtering mesh of 300 to 30 mesh installed internally, such that when liquid flows into the nanobubble generating device, any debris which may cause blockage or damage to the passage of the nanobubble generating device are filtered out.

The filtered flow then enters the frustoconical-shaped inlet passage 101 through its wider part. As the flow passes through the frustoconical-shaped inlet passage 101, the cross-sectional diameter decreases as the passage constricts, such that the velocity increases and pressure decreases, according to Bernoulli's principle.

The flow then passes into the tubular flow-constricting tunnel 102 through the narrower part of the frustoconical frustoconical-shaped inlet passage 101. The ratio of the cross-sectional diameters of the wider part to that of the narrower part of the frustoconical-shaped inlet passage is 1:1.5 to 1:2. In addition, a gas inlet 107 is perpendicularly connected to the tubular flow-constricting tunnel 102, through which gas is drawn into the liquid flow due to Venturi effect, causing turbulence in the flow. The turbulent flow then collides with the walls of the tunnel, creating microscopic to nanoscopic bubbles in the process. The ratio of the cross-sectional diameter of the tubular flow-constricting tunnel 102 to the frustoconical-shaped inlet passage 101 may range from 1:3.5 to 1:4.5.

The gas may be supplied by ambient air, an oxygen concentrator, an ozone generator or a gas cylinder.

The nanobubble flow then exits the tubular flow-constricting tunnel 102 into the narrower part of the frustoconical shaped outlet passage 103, where the ratio of the cross-sectional diameter of the tubular flow-constricting tunnel 102 to the frustoconical-shaped outlet passage 103 is 1:5 to 1:6

The ratio of the length of the frustoconical-shaped inlet passage 101 to the length of the inverted frustoconical-shaped outlet passage 103 may be 1:4 to 1:5.

Due to the increase in cross-sectional diameter through the frustoconicalfrustoconical-shaped passage 103, the velocity of the bubble-infused flow decreases, and will come into contact with multiple stacks of porous layers 104.

Each stack of the porous layers contains multiple coarse, rimless porous membranes with pore size of 76-90 μm, and each stack of membranes has a total thickness of 0.45-0.90 mm. The gap between any two stacks of porous layers should range from 2.25 mm to 2.75 mm, and the multiple stacks of porous layers 104 comprises at least two stacks of porous layers.

When the bubble-infused flow collides with the multiple stacks of porous layers 104, the miniscule irregular flow pathways through the overlapped porous membranes shear through larger scale bubbles creating smaller ones, ensuring the bubbles emerging from the multiple layers of porous membranes are nanoscale bubbles.

As described above, the nanobubble generating device does not rely on electrical power, and does not require a water tank or recirculation system to operate. As such, the device is very portable and versatile, and only requires a liquid flow of minimum liquid pressure 2 bar and minimum flow velocity of 24 liters per minute to efficiently generate a nanobubble flow.

Accordingly, the nanobubble generating device of the present invention can be simply installed onto a water faucet of municipal water supply for facile nanobubble generation as a high-efficiency, low-cost and environmentally-friendly option having multiple fields of applications.

As used herein, terms “approximately”, “basically”, “substantially”, and “about” are used for describing and explaining a small variation. When being used in combination with an event or circumstance, the term may refer to a case in which the event or circumstance occurs precisely, and a case in which the event or circumstance occurs approximately. As used herein with respect to a given value or range, the term “about” generally means in the range of ±10%, ±5%, ±1%, or ±0.5% of the given value or range. The range may be indicated herein as from one endpoint to another endpoint or between two endpoints. Unless otherwise specified, all the ranges disclosed in the present disclosure include endpoints. The term “substantially coplanar” may refer to two surfaces within a few micrometers (μm) positioned along the same plane, for example, within 10 μm, within 5 μm, within 1 μm, or within 0.5 μm located along the same plane. When reference is made to “substantially” the same numerical value or characteristic, the term may refer to a value within ±10%, ±5%, ±1%, or ±0.5% of the average of the values.

The foregoing description of the present invention has been provided for the purposes of illustration and description. It is not intended to be exhaustive or to limit the invention to the precise forms disclosed. Many modifications and variations will be apparent to the practitioner skilled in the art.

The embodiments were chosen and described in order to best explain the principles of the invention and its practical application, thereby enabling others skilled in the art to understand the invention for various embodiments and with various modifications that are suited to the particular use contemplated.

1. A lightweight, free-standing, non-electricity driven and municipal water supply-applicable nanobubble generating device, comprising:
a liquid inlet;
a liquid outlet;
a frustoconical-shaped inlet passage, wherein the wider part of the frustoconical shape is connected to the liquid inlet;
multiple stacks of porous layers connected to the liquid outlet, wherein the number of stacks of porous layers is at least 2;
an inverted frustoconical-shaped outlet passage, wherein the wider part of the frustoconical shape is connected to the multiple stacks of porous layers;
a tubular flow-constricting tunnel interconnecting the narrower part of the frustoconical-shaped inlet passage and the narrower part of the inverted frustoconical-shaped outlet passage, and
a gas inlet externally connected to a gas supply, wherein the gas inlet is perpendicularly connected to the tubular flow-constricting tunnel;
wherein the liquid inlet further comprises a filtering mesh of 300 to 350 mesh;
wherein the gas inlet further comprises a non-return valve;
wherein the concentration of the nanobubble generated is at least 1×10⁷ particles/mL under a liquid flow into the device through the inlet with liquid pressure of at least 2 bar and flow rate of at least 24 litres per minute.

2. The lightweight, free-standing, non-electricity driven and municipal water supply-applicable nanobubble generating device of claim 1, wherein the ratio of the cross-sectional diameter of the wider part of the frustoconical-shaped inlet passage to the cross-sectional diameter of the tubular flow-constricting tunnel is 1:1.5 to 1:2.

3. The lightweight, free-standing, non-electricity driven and municipal water supply-applicable nanobubble generating device of claim 1, wherein the ratio of the length of the liquid inlet to the length of the liquid outlet is 1:4 to 1:5.

4. The lightweight, free-standing, non-electricity driven and municipal water supply-applicable nanobubble generating device of claim 1, wherein the ratio of the cross-sectional diameter of the tubular flow-constricting tunnel to the cross-sectional diameter of the wider parts of the frustoconical-shaped inlet passage is 1:3.5 to 1:4.5.

5. The lightweight, free-standing, non-electricity driven and municipal water supply-applicable nanobubble generating device of claim 1, wherein the ratio of the cross-sectional diameter of the tubular flow-constricting tunnel to the cross-sectional diameter of the wider part of the inverted frustoconical-shaped outlet passage is 1:5 to 1:6.

6. The lightweight, free-standing, non-electricity driven and municipal water supply-applicable nanobubble generating device of claim 1, wherein the multiple stacks of porous layers each further comprises at least 2 overlapping rimless coarse membranes with pore size of 70-90 μm.

7. The lightweight, free-standing, non-electricity driven and municipal water supply-applicable nanobubble generating device of claim 1, wherein each stack of the multiple stacks of porous layers has a total thickness of 0.45-0.90 mm.

8. The lightweight, free-standing, non-electricity driven and municipal water supply-applicable nanobubble generating device of claim 1, wherein the gap between each stack of the multiple stacks of porous layers is 2.25-2.75 mm.

9. A method of generating nanobubbles directly from a water source with the lightweight, free-standing, non-electricity driven and municipal water supply-applicable nanobubble generating device of claim 1, comprising:
aligning the device to a water supply;
connecting an external gas supply to the gas inlet of the device to allow gas supply into the device through the gas inlet,
switch on the water supply and control the water flow into the device through the inlet to have a liquid pressure of at least 2 bar and flow rate of at least 24 litres per minute; and
receiving the nanobubble flow through the outlet of the device;
wherein the concentration of nanobubbles in the nanobubble flow generated is at least 1×10⁷ particles/ml.

10. The method of generating nanobubbles of claim 9, wherein the external gas supply is selected from ambient air, oxygen concentrator, ozone generator or gas cylinder.

11. The method of generating nanobubbles of claim 9, wherein the nanobubble flow is generated without the use of electrical power supply.
